(19) United States
(12) Patent Application Publication
(10) Pub. No.: US 2007/0001851 A1
(43) Pub. Date: Jan. 4, 2007

(54) Configurable, calibrated radio frequency identification tag system

(75) Inventors: Matthew Stephen Reynolds, Medford, MA (US); Bernd Schoner, Cambridge, MA (US)

Correspondence Address: DAVIDSON BERQUIST JACKSON & GOWDEY LLP, 4300 WILSON BLVD., 7TH FLOOR, ARLINGTON, VA, 22203, US

(73) Assignee: ThingMagic, Inc., Cambridge, MA (US)

(21) Appl. No.: 11/171,444

(22) Filed: Jul. 1, 2005

(51) Int. Cl. G08B 13/14

(52) U.S. Cl. 340/572.1

(57) ABSTRACT

A simulated RFID tag may be combined with other such tags to form a population of simulated tags. A method of testing an RFID reader includes providing at least one population of simulated RFID tags; configuring tags in the at least one population of simulated RFID tags; and querying the at least one population of simulated RFID tags with the RFID reader. The simulated RFID tags may be configured by assigning arbitrary static IDs to at least some of the simulated RFID tags; assigning a sequence of tag IDs to at least some of the simulated RFID tags; assigning a sequence of time-varying IDs to at least some the population of simulated RFID tags; and assigning arbitrary timing/persistence to at least some of the simulated RFID tags.

### FIELD OF THE INVENTION

This invention relates to Radio Frequency Identification (RFID) systems.

### BACKGROUND AND OVERVIEW

According to some aspects, this invention provides a calibrated simulator RFID tag system or so-called “Golden Tag System”. The invention allows for the evaluation of various emerging RFID protocols. Such a system allows abstraction from the variability of an RF environment, as well as tag-to-tag variation in the case of single chip tags, in order to allow for the objective evaluation of an RFID protocol, or a candidate reader implementation of an RFID protocol, in the presence of a physical communication channel. Such a system, according to embodiments of the present invention, may be used, e.g., to establish benchmarks for vendor implementations of different protocol standards. The Golden Tag Systems according to the present invention allow measurement of RFID systems (referred to herein as system(s) under test) to determine if the systems under test are compatible with a given protocol specification, and/or to extract performance measurements from the system under test.

A Golden Tag System according to embodiments of the present invention enables:
objective evaluation, comparison, and benchmarking of RFID protocols;
evaluation and certification of RFID readers;
benchmarking of passive RFID tags;
evaluation and testing of RF environments.

### BRIEF DESCRIPTION OF THE DRAWINGS

The invention is better understood by reading the following detailed description with reference to the accompanying drawings in which:

FIG. 1 is a block diagram of a tag unit according to embodiments of the present invention;

FIG. 2 is a block diagram of a tag population simulator according to embodiments of the present invention; and

FIG. 3 is an overview of a tag simulation and test system according to embodiments of the present invention.

### DESCRIPTION OF PRESENTLY PREFERRED EXEMPLARY EMBODIMENTS

As used herein, the following terms have the following meanings. These terms are defined here to be used in describing exemplary embodiments, and are not meant to limit the scope of the invention in any way:

EPC refers to an Electronic Product Code which provides a numbering standard.

FPGA means a Field Programmable Gate Array which is generally an array of logic gates that can be hardware-programmed to fulfill user-specified tasks.

SMA refers to Sub-Miniature version A connectors for radio-frequency circuits.

UHF means ultrahigh frequency and generally refers to a range of the radio spectrum in the band extending from 300 MHz to 3 GHz.

A Golden Tag

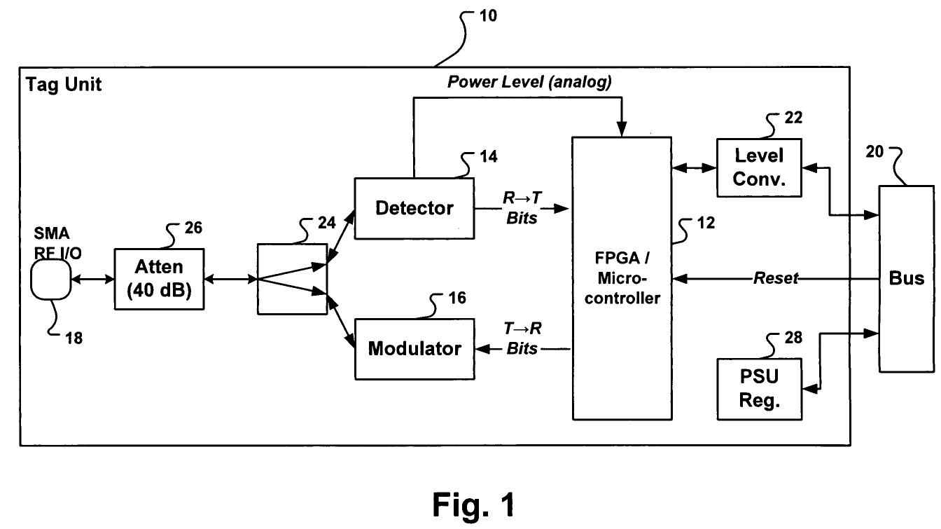

FIG. 1 is a schematic block diagram of a tag unit or simulator (a “golden” tag) according to embodiments of the present invention. (The terms “tag unit” “golden tag” and “tag simulator” are used synonymously herein.) As shown in FIG. 1, a tag unit 10 according to embodiments of the present invention includes an FPGA 12. The FPGA may be combined with or replaced by a microcontroller (such as, e.g., a TI MSP430). For convenience of explanation of the present invention, the FPGA/microcontroller are jointly referred to by the reference number 12. One skilled in the art will realize that the various functions of the FPGA and the microcontroller may be split in many ways, and that, in some embodiments, all of the processing may take place in a software-programmed microprocessor or in the FPGA. Preferably, however, the FPGA 12 handles the necessary high-speed logic for high-bit-rate applications (such as UHF EPC Class 0 applications), while the microcontroller controls various operations of the tag unit including measuring signal strength, loading the tag's EPC number, handling read confirmations, communicating with the attached computer, and loading the FPGA at boot time.

A tag unit 10 also includes a detector 14 and a modulator 16, each connected to the FPGA/microcontroller 12. An RF I/O port/connector 18 (such as an SMA connector) provides for external RF connection of the tag unit 10. In addition, the tag unit 10 may interconnect with other tag units via bus 20. The bus 20 may be, e.g., an RS-485 bus, and preferably the connection to the bus is via an RS-485 port. The bus 20 may also be used to supply power to modules of the tag unit. The bus 20 may also provide external signals to the tag unit, such as a reset signal to restart the tag simulator, if necessary.

The FPGA/microcontroller 12 connects to the bus 20 through a level converter 22 which functions to interface the FPGA and/or microcontroller's logic levels to the bus 20's logic levels. This may also include optical isolation or other means of preventing radio frequency interference between the tag unit 10 and other such units or the attached computer.

A power supply unit (PSU) 28 connects to the bus 20 to extract power to operate tag unit 10 from the bus power, if desired.

The detector 14 connects to the RF I/O port 18 via a two-way power splitter 24 and an attenuator 26. The modulator 16 also connects to the RF I/O port 18 via the two-way power splitter 24 and the attenuator 26. In presently preferred embodiments, the attenuator 26 is a 40 dB attenuator. In some embodiments, the attenuator 26 may be a variable/adjustable attenuator, so as to allow for the simulation of various read ranges and signal strengths The I/O port 18 is connectable to the RF ports of an RFID reader or some other device (not shown in figure).

In operation, a read signal (from a reader—not shown) is received via the RF I/O port 18. The detector 14 provides the power level of the received read signal to the FPGA/microcontroller 12, preferably as an analog signal. Additionally, the detector 14 provides information from the reader (reader-to-tag information, shown in the drawing as R->T bits) to the FPGA/microcontroller 12. In response, and based at least in part on the signals received from the detector 14, the FPGA/microcontroller 12 may return an EPC code (or some identifier) stored therein.

If the FPGA/microcontroller 12 does respond to a read signal, the value it provides (shown in the drawing as T->R bits) is modulated (by modulator 16) and sent to the RF I/O port 18 for transmission to an RFID reader (not shown) connected thereto.

A Tag Population

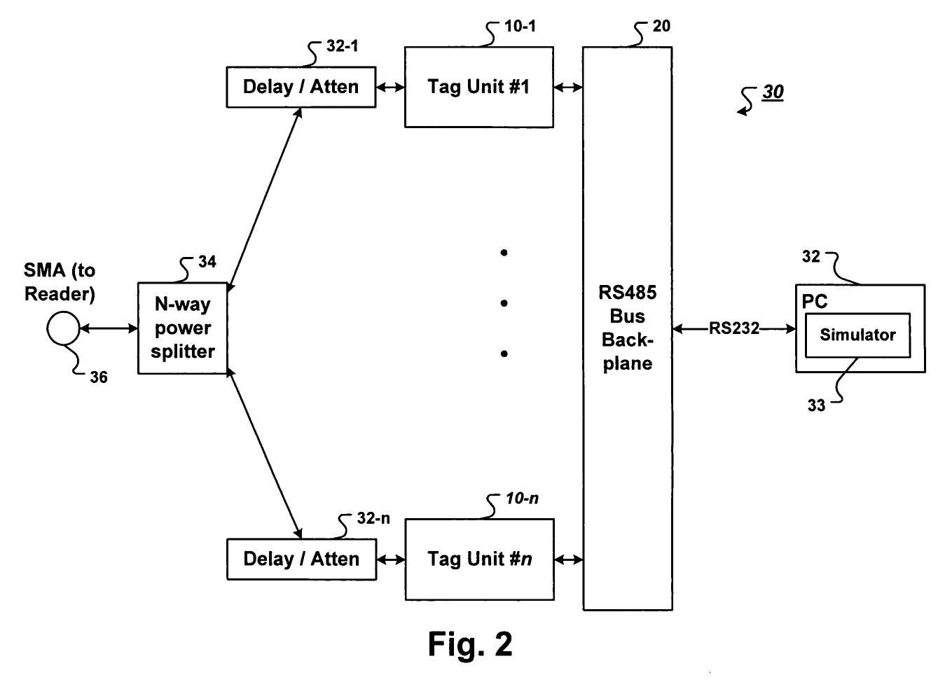

A tag population simulator is made up of a collection or bank of tag units/simulators such as those described above with reference to FIG. 1. That is, a tag population is made up of a collection of golden tags. FIG. 2 is a block diagram of a tag population simulator 30 according to embodiments of the present invention. As shown in the drawing, a tag population simulator 30 is made up of a number of tag units/simulators (Tag Unit # 110-1 . . . Tag Unit #n 10-n), each connected to a bus 20 (preferably a RS-485 bus). A computer (PC 32) is also connected to the bus 20, e.g., via a serial RS232 connection, allowing communication between the computer (PC 32) and each tag unit 10-1 . . . 10-n in the tag population In a presently preferred embodiment, up to 255 tag units may be interconnected to form a population simulator.

Each tag unit 10-k in a tag population simulator 30 is connected (via its respective RF I/O port) to a variable/programmable delay/attenuator mechanism 32-k. Thus, as shown in FIG. 2, tag unit #110-1 is connected to delay/attenuator 32-1, etc. Through their respective delay/attenuator mechanisms 32-k, each tag unit 10-k connects (via an N-way power splitter 34) to an SMA 36 (which is connectable to a reader—not shown).

A golden tag population simulator according to embodiments of the present invention provides/supports some or all of the following features:
Tag modules for HF EPC Class 1, ISO18000, and UHF EPC Class 0/1/Class 1 Generation 2.
Tag modules that may be reprogrammed to accommodate different protocols, including future protocol changes.
Scalable population (e.g., from 1 tag up to 255 simultaneous tags in the read field).
Calibrated, consistent receiver sensitivity and modulator reflection coefficient for each tag.
Dynamically assignable EPC (or an alternative numbering scheme if desired) numbers for all tags.
Dynamic confirmation of each tag's response to specific reader commands (e.g., for EPC Class 1 sleep or scroll).
Varying attenuation and phase to simulate various read ranges and signal strengths.
Generate configurable test modulation of known frequency and bit pattern for reader signal-to-noise testing and demodulation testing.

In some embodiments, the tag units may be implemented on two inch by three inch PCBs with a stacking bus connector, allowing a varying number of tag units to be interconnected to a backplane module which is in turn connected to a PC via a serial port interface.

Simulator Software

The computer 32 connected to the golden tag population runs simulator software 33 which implements/supports at least some of the following features:
A list of specific EPC numbers (or any other tag identifier) from a text file may be loaded in to each tag unit in the population.
A random population may be assigned from a certain arbitrary subset of EPC numbers (or any other tag identifier).
The simulator may provide timing to indicate the relative read times of each tag unit. In some presently preferred embodiments, this timing may be specified with millisecond precision.
The simulator may provide an indication of how many tag responses were provided (this aspect is protocol dependent).
The simulator may be set to allow only a certain subset of the tag units to respond to queries, thus allowing the population size to be varied.
The simulator's software may load new firmware in to each tag unit's FPGA and microcontroller to adapt to future protocol versions.
The simulator software may run on any computer such as, e.g., on a PC running the Linux or Windows operating systems.

In operation, a tag population simulator according to embodiments of the present invention provides a calibrated simulation of a large population of tags, e.g., for the purpose of measuring EPC reader performance.

The simulator software is not limited to the above-mentioned functionality, and one skilled in the art will realize that additional and/or different functions may be provided by the simulator software. Furthermore, the simulator software may by customized for specific protocols.

In some embodiments, some or all of the simulator software's functionality may be provided via a command line interface (CLI). In this manner, the test commands may be used as part of a script which executes a suite of tests in sequence, making manufacturing tests, acceptance tests, and performance benchmarking of new reader devices as simple as possible. In addition to the command line interface, some embodiments may provide a graphical user interface that would provide intuitive access to the test modes for bench testing.

In some presently preferred embodiments, the tag units in a population include EPC Class 1 UHF simulator tags and/or EPC Class 1, EPC Class 1 Generation 2, and Class 0 UHF simulator tags and/or EPC HF simulator tags. The EPC Class 1 UHF simulator tags are preferably capable of running the full Auto-ID UHF EPC Class 1 protocol, including Class 1 Generation 2 support, and each such tag is microprocessor-based and includes an RS232 Port, an RS485 Port, a basic API, an antenna Port and calibrated RF performance. The EPC Class 1 and Class 0 UHF simulator tags are capable of running the full UHF EPC Class 1 and EPC Class 0 protocols, and the EPC HF simulator tags are capable of running the HF EPC protocol.

In some presently preferred embodiments, the population simulator boards are capable of connecting up to 30 HF or UHF tags (including mixed populations). Some embodiments of the present invention provide the ability to connect multiple boards to the host PC.

Golden Tag Simulation and Test System

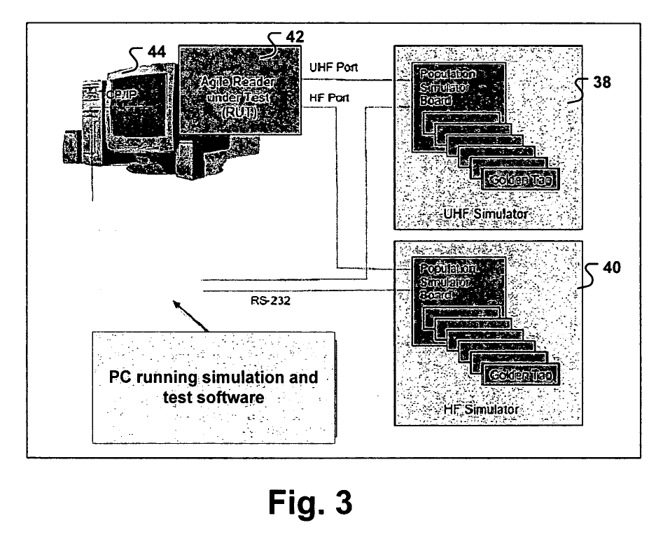

FIG. 3 provides an overview example of a golden tag simulation and test system according to embodiments of the present invention. As shown in the drawing, two population simulators—UHF simulator 38 and HF simulator 40 are connected to the UHF and HF ports, respectively, of reader under test (RUT) 42. The two simulators are also connected to computer 44 (the PC running the simulation and test software). The computer 44 connects to the reader under test 42 via an Ethernet connection.

A test application running on the computer 44 executes some or all of the following tests by interacting with the reader under test (RUT) via the Ethernet network. (Most of the interaction consists of configuration tasks, reader queries and performance benchmarking):
Query the population of tags with fixed tag IDs. Record the number of reads of every tag in a predetermined time-interval;
Record the average signal strength of an individual tag-to-reader link;
Record the rate of successful decodes of individual tags;
Record the raw tag through put/scroll through put.

The computer test application may set up the tags in various configurations in order to enable certain tests, and may read certain measurements from the tags after completion of the tests. To avoid unpredictable interactions between the test software and the reader under test, the computer application preferably only interacts with the tags before and after an experiment. The PC application may provide some or all of the following functionality relative to the tags simulators (Golden tags):
Assign arbitrary static tag IDs to the individual tags;
Assign a sequence of tag IDs to the individual tags, mimicking a rapidly varying population of tags. In this scenario a tag may increment its ID visible to the reader whenever it is successfully read and put to sleep;
Assign a sequence of time-varying IDs to the individual tags;
Assign arbitrarily timing/persistence to the individual tags. This may be useful in view of expected silicon tags with varying persistence of sleep;
Configure the tags to measure signal strength of the reader-to-tag communication and read the results from the tags.

While one skilled in the art will realize that any number of hardware configurations are possible using the simulator tags and tag population simulators of the present invention, a presently preferred hardware configuration includes the following:
30 EPC UHF Class 1 Tags
30 EPC HF Tags
two population simulator boards to enable an HF and an UHF tag tree by interconnecting tags

The present invention thus provides, in some aspects, so-called “golden” RFID tags and related systems and methods. There is an acute need for such systems, e.g., when developing, testing, and benchmarking RFID readers. They are also valuable tools for tag protocol development, since each tag population board may contain a microcontroller or FPGA implementation of the protocol being developed.

While some aspects of the invention have been described as being implemented in hardware or software, one skilled in the art will realize that certain elements may be implemented in hardware, software or combinations thereof.

While the invention has been described in connection with what is presently considered to be the most practical and preferred embodiment, it is to be understood that the invention is not to be limited to the disclosed embodiment, but on the contrary, is intended to cover various modifications and equivalent arrangements included within the spirit and scope of the appended claims.

We claim:

1. A simulated Radio Frequency Identification (RFID) tag comprising:
a receiver mechanism constructed and adapted to receive signals from an RFID reader; and
a processor mechanism constructed and programmed to simulate an RFID tag.

2. A simulated RFID tag as in claim 1 wherein the processor mechanism is further constructed and adapted to analyze the signals received from the RFID reader and to selectively provide a response to the signals.

3. A simulated RFID tag as in claim 2 wherein the selectively provided response corresponds to an Electronic Product Code (EPC) or another identifier associated with the tag.

4. A simulated RFID tag as in claim 2 wherein the processor mechanism is further constructed and adapted to have an EPC number, or another identifier, dynamically assigned thereto.

5. A simulated RFID tag as in claim 1 wherein the processor mechanism is constructed and adapted to simulate an RFID tag selected from the group consisting of: HF EPC Class 1 tags and UHF EPC Class 0/1/Class 1 Generation 2 tags.

6. A simulated RFID tag as in claim 1 wherein the processor mechanism is constructed and adapted to simulate differing receiver sensitivity and modulation reflection for the tag.

7. An RFID tag population simulator comprising:
one or more simulated RFID tags connected to a bus, each RFID tag including: a receiver mechanism constructed and adapted to receive signals from an RFID reader; and a processor mechanism constructed and programmed to simulate an RFID tag; and
a computer connected to the bus to selectively control the simulated RFID tags.

8. An RFID tag population simulator as in claim 7 further comprising:
a plurality of delay/attenuator mechanisms connected to respective ones of said simulated RFID tags, each said delay/attenuator mechanism being adjustable by the computer.

9. An RFID tag population simulator as in claim 7 wherein the computer is programmed to perform one or more of the following:
(a) configure each of the one or more simulated RFID tags as either an HF EPC Class 1 tag or a UHF EPC Class 0/1/Class 1 Generation 2 tag, or any other RFID tag protocol;
(b) calibrate receiver sensitivity and modulator reflection coefficient for each of the one or more simulated RFID tags;
(c) dynamically assign an EPC number to each of the one or more simulated RFID tags;
(d) dynamically confirm each tag's response to specific reader commands; and
(e) vary attenuation and phase for each of the one or more simulated RFID tags in order to simulate various read ranges and signal strengths.

10. An RFID tag population simulator as in claim 7 comprising between 1 and 255 simulated RFID tags.

11. A method of testing an RFID reader comprising:
providing at least one population of simulated RFID tags;
configuring tags in the at least one population of simulated RFID tags; and
querying the at least one population of simulated RFID tags with the RFID reader.

12. A method as in claim 11 wherein the step of configuring tags further comprises one or more of the following:
(a) assigning arbitrary static IDs to at least some of the simulated RFID tags;
(b) assigning a sequence of tag IDs to at least some of the simulated RFID tags;
(c) assigning a sequence of time-varying IDs to at least some the population of simulated RFID tags; and
(d) assigning arbitrary timing/persistence to at least some of the simulated RFID tags.

13. A method as in claim 11 wherein at least two populations of simulated RFID tags are provided, and wherein each population simulates tags from the same or different radio frequency band.

14. A method as in claim 11 further comprising:
recording one or more of the following:
(a) a number of reads of every simulated tag in a predetermined time interval;
(b) an average signal strength of an individual tag-to-reader link;
(c) a rate of successful decodes of individual tags;
(d) a raw tag throughput; and
(e) a time-domain representation of data sent from the RFID reader to a tag.

15. A method as in claim 11 wherein the at least one population of simulated RFID tags comprises:
one or more simulated RFID tags connected to a bus, each RFID tag including: a receiver mechanism constructed and adapted to receive signals from an RFID reader; and a processor mechanism constructed and programmed to simulate an RFID tag.

16. A method as in claim 15 wherein each simulated RFID tag is constructed and adapted to simulate an RFID tag selected from the group consisting of: HF EPC Class 1 tags and UHF EPC Class 0/1/Class 1 Generation 2 tags.
